(19) United States
(12) Patent Application Publication
(10) Pub. No.: US 2023/0017642 A1
(43) Pub. Date: Jan. 19, 2023

(54) CYANO-CONTAINING ORGANOFLUOROBORATE ADDITIVES FOR LITHIUM ION BATTERIES

(71) Applicant: Apple Inc., Cupertino, CA (US)

(72) Inventors: Hongli Dai, Los Altos, CA (US); Jongho Jeon, San Jose, CA (US); Libo Hu, Mountain View, CA (US); Paul M. Bayley, Santa Clara, CA (US); Khalil Amine, Oak Brook, IL (US); Mingfu He, Palos Park, IL (US); Qian Liu, Darien, IL (US); Zhengcheng Zhang, Naperville, IL (US)

(21) Appl. No.: 17/835,766

(22) Filed: Jun. 8, 2022

Related U.S. Application Data
(60) Provisional application No. 63/211,825, filed on Jun. 17, 2021.
(60) Provisional application No. 63/248,235, filed on Sep. 24, 2021.
(60) Provisional application No. 63/248,214, filed on Sep. 24, 2021.

(51) Int. Cl. H01M 10/0567; H01M 10/46; H01M 4/04; H01M 10/0568; H01M 10/0569

(52) U.S. Cl. CPC H01M 10/0567; H01M 10/46; H01M 4/0404; H01M 10/0568; H01M 10/0569; H01M 2300/0042

(57) ABSTRACT

This disclosure relates generally to battery cells, and more particularly, electrolyte additives for use in lithium ion battery cells.

### CROSS-REFERENCE TO RELATED PATENT APPLICATION

This patent application claims the benefit under 35 U.S.C. § 119(e) of U.S. Patent Application No. 63/211,825, entitled “Cyano-Containing Organofluoroborate Additives for Lithium Ion Batteries”, filed on Jun. 17, 2021, U.S. Patent Application No. 63/248,235, entitled “Cyano-Containing Organofluoroborate Additives for Lithium Ion Batteries”, filed on Sep. 24, 2021, and U.S. Patent Application No. 63/248,214, entitled “Cyano-Containing Organofluoroborate Additives for Lithium Ion Batteries”, filed on Sep. 24, 2021, each of which are incorporated herein by reference in its entirety.

### U.S. GOVERNMENT LICENSE RIGHTS

This invention was made with U.S. government support under WFO Proposal No. 85C85. This invention was made under a CRADA 1500801 between Apple Inc. and Argonne National Laboratory operated for the United States Department of Energy. The U.S. government has certain rights in the invention.

### FIELD

This disclosure relates generally to battery cells, and more particularly, electrolyte additives for use in lithium ion battery cells.

### BACKGROUND

Li-ion batteries are widely used as the power sources in consumer electronics. Consumer electronics need Li-ion batteries which can deliver higher volumetric energy densities and sustain more discharge-charge cycles. A Li-ion battery typically works at a voltage up to 4.45 V (full cell voltage).

A battery life cycle can deteriorate due to instability of cathode structure and electrolyte degradation. The cathode material stability can be improved by the modification of LiCoO₂ such as doping and surface coating. Limited progress has been made in developing electrolytes that can enable both high volumetric energy densities and long battery cycling life. Most existing electrolytes suffer from poor ability to form stable cathode-electrolyte (CEI) and/or solid-electrolyte interphases (SEI), leading to fast interfacial impedance growth and capacity decay.

### SUMMARY

In a first aspect, the disclosure is directed to an electrolyte fluid comprising at least 0.01 wt % of an additive selected from a compound of Formula (I), Formula (II), Formula (III), and Formula (IV).

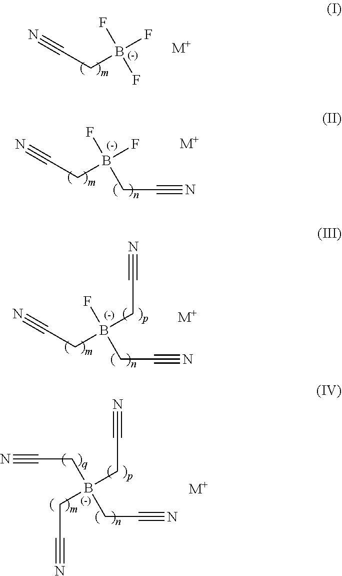

In a second aspect, the disclosure is directed to an electrolyte fluid comprising at least 0.01 wt % of an additive selected from a compound of Formula (I), Formula (II), and Formula (III). The electrolyte fluid can comprise at least 0.01 wt % of a compound of Formula (I). The electrolyte fluid can comprise at least 0.01 wt % of a compound of Formula (II). The electrolyte fluid can comprise at least 0.01 wt % of a compound of Formula (III). The electrolyte fluid can comprise at least 0.01 wt % of a compound of Formula (IV).

When the additive is the compound of Formula (I), m is an integer equal to or greater than 1 and equal to or less than 9, and M⁺ is selected from an alkali metal ion, a quaternary ammonium ion, an imidazolium ion, and a quaternary phosphonium ion.

When the additive is the compound of Formula (II), m is an integer equal to or greater than 1 and equal to or less than 9, n is an integer equal to or greater than 1 and equal to or less than 9, and M⁺ is selected from an alkali metal ion, a quaternary ammonium ion, an imidazolium ion, and a quaternary phosphonium ion.

When the additive is the compound of Formula (III), m is an integer equal to or greater than 1 and equal to or less than 9, n is an integer equal to or greater than 1 and equal to or less than 9, p is an integer equal to or greater than 1 and equal to or less than 9, and M⁺ is selected from an alkali metal ion, a quaternary ammonium ion, an imidazolium ion, and a quaternary phosphonium ion.

When the additive is the compound of Formula (IV), m is an integer equal to or greater than 1 and equal to or less than 9, n is an integer equal to or greater than 1 and equal to or less than 9, p is an integer equal to or greater than 1 and equal to or less than 9, q is an integer equal to or greater than 1 and equal to or less than 9, and M⁺ is selected from an alkali metal ion, a quaternary ammonium ion, an imidazolium ion, and a quaternary phosphonium ion.

In some variations, the additive is the potassium organotrifluoroborate compound potassium (cyanomethyl)trifluoroborate (PCTFB). In some variations, the additive is the organotrifluoroborate lithium (cyanomethyl)trifluoroborate (LiCTFB).

In some variations, the electrolyte fluid can be an electrolyte salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

In some variations, the electrolyte fluid can include a solvent selected from ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), and a combination thereof.

In some variations, the electrolyte fluid can include an additive selected from (LiDFOB), pro-1-ene-1, 3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), 1,3,6-hexanetricarbonitrile (HTCN), and a combination thereof.

In some variations, the disclosure is directed to a battery cell. The battery cell can include a cathode having a cathode active material disposed on a cathode current collector, and an anode having an anode active material disposed on an anode current collector. The anode is oriented towards the cathode such that the anode active material faces the cathode active material. A separator is disposed between the cathode active material and the anode active material. An electrolyte fluid as described herein is disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment; and

FIG. 2 is a perspective view of a battery cell in accordance with an illustrative embodiment;

FIG. 3 presents cycle performance energy retention at cycle 201 for a battery operating at 45° C. of the control electrolyte as compared to the control including 0.5 wt % PCTFB, according to an illustrative embodiment;

FIG. 4 presents the RSS at cycle 201 for a battery operating at 45° C. of the control electrolyte as compared to the control including 0.5 wt % PCTFB, according to an illustrative embodiment;

FIG. 5 presents a plot of the cycling performance energy retention at cycle 200 at 45° C. of the control electrolyte as compared to the control including 0.5 wt % PCTFB, according to an illustrative embodiment;

FIG. 6 depicts RSS as a function of battery cycle count at 45° C. for a battery having a control electrolyte and an electrolyte including 0.5 wt % PCTFB, according to an illustrative embodiment;

FIG. 7 depicts the capacity recovery of different electrolyte compositions containing HTCN and optionally LiCTFB after 8 hours of battery storage at 85° C., according to an illustrative embodiment;

FIG. 8 depicts improved lithium plating of different electrolyte compositions containing HTCN and optionally LiCTFB after battery operation at −3° C., according to an illustrative embodiment; and

FIG. 9 depicts formation of a solid-electrolyte interface, according to an illustrative embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

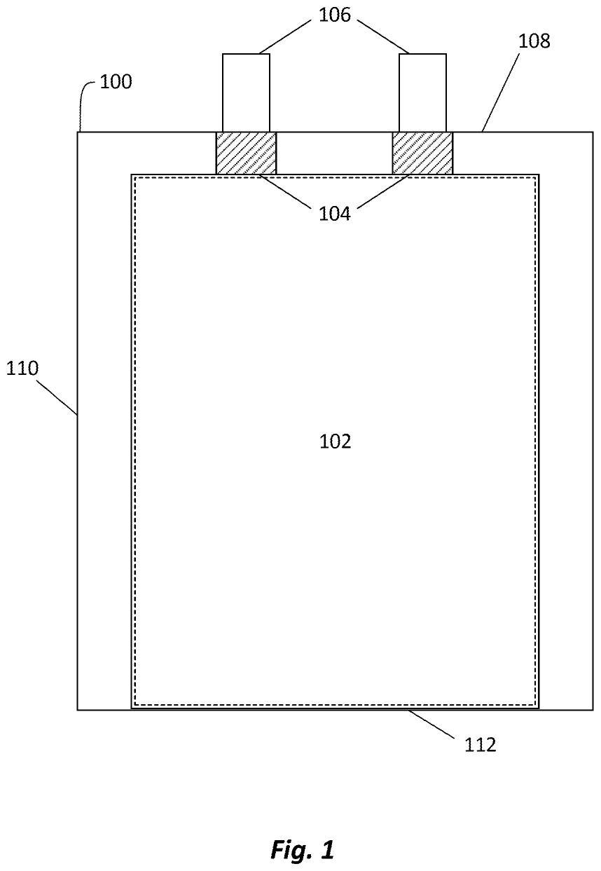

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

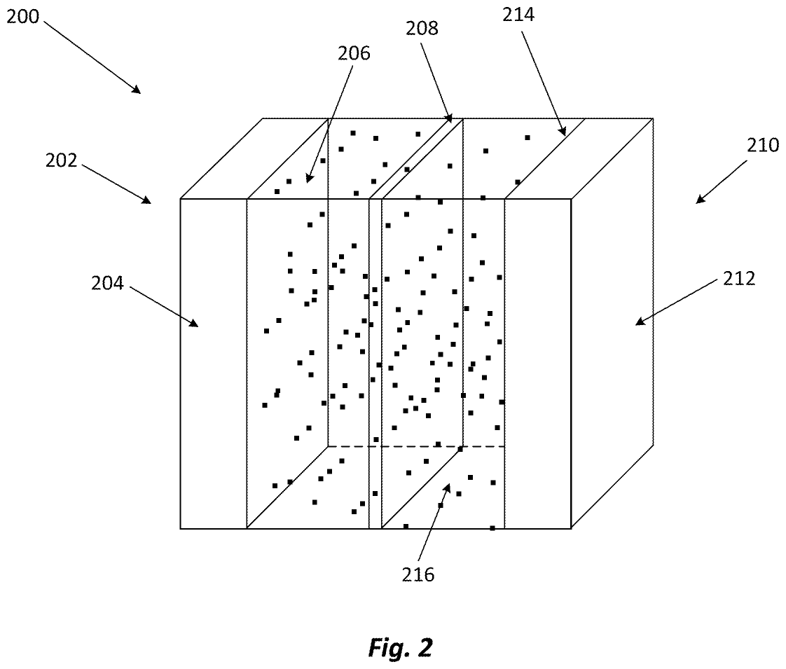

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material described in, for example, U.S. Ser. Nos. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte fluid can act a conductive pathway for the movement of cations passing from the negative to the positive electrodes during discharge. The electrolyte fluid includes an electrolyte salt, electrolyte solvent, and one or more electrolyte additives.

The electrolyte fluid includes an electrolyte solvent. The electrolyte solvent may be any type of electrolyte solvent suitable for battery cells. Non-limiting examples of the electrolyte solvents include propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), or combinations thereof.

The electrolyte fluid also has one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], and LiC(SO₂CF₃)₃. Other salts are possible, including combinations of salts.

In some variations, the salt is at least 0.1 M in the total electrolyte fluid. In some variations, the salt is at least 0.2 M in the total electrolyte fluid. In some variations, the salt is at least 0.3 M in the total electrolyte fluid. In some variations, the salt is at least 0.4 M in the total electrolyte fluid. In some variations, the salt is at least 0.5 M in the total electrolyte fluid. In some variations, the salt is at least 0.6 M in the total electrolyte fluid. In some variations, the salt is at least 0.7 M in the total electrolyte fluid. In some variations, the salt is at least 0.8 M in the total electrolyte fluid. In some variations, the salt is at least 0.9 M in the total electrolyte fluid. In some variations, the salt is at least 1.0 M in the total electrolyte fluid. In some variations, the salt is at least 1.3 M in the total electrolyte fluid. In some variations, the salt is at least 1.6 M in the total electrolyte fluid. In some variations, the salt is at least 1.9 M in the total electrolyte fluid.

In some variations, the salt is less than or equal to 2.0 M in the electrolyte fluid. In some variations, the salt is less than or equal to 1.9 M in the electrolyte fluid. In some variations, the salt is less than or equal to 1.6 M in the electrolyte fluid. In some variations, the salt is less than or equal to 1.3 M in the electrolyte fluid. In some variations, the salt is less than or equal to 1.1 M in the electrolyte fluid. In some variations, the salt is less than or equal to 1.0 M in the electrolyte fluid. In some variations, the salt is less than or equal to 0.9 M in the electrolyte fluid. In some variations, the salt is less than or equal to 0.8 M in the electrolyte fluid. In some variations, the salt is less than or equal to 0.7 M in the electrolyte fluid. In some variations, the salt is less than or equal to 0.6 M in the electrolyte fluid. In some variations, the salt is less than or equal to 0.5 M in the electrolyte fluid. In some variations, the salt is less than or equal to 0.4 M in the electrolyte fluid. In some variations, the salt is less than or equal to 0.3 M in the electrolyte fluid. In some variations, the salt is less than or equal to 0.2 M in the electrolyte fluid.

In some variations, disclosure is directed to electrolyte fluids that include one or more cyano-containing organotrifluoroborate additive selected from compound of Formula (I), (II), (III), or (IV).

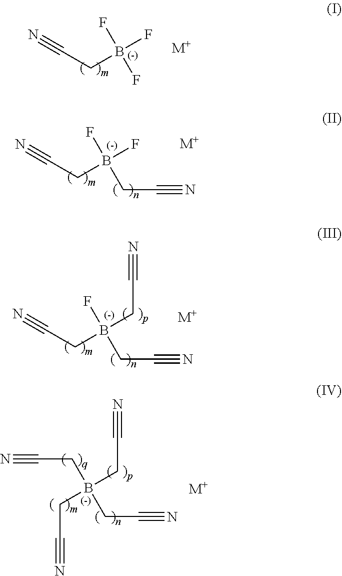

In one variation, the electrolyte solution comprises an additive having the structure of Formula (I), wherein m is not equal to zero. In some variations, increasing the value of m extends the carbon chain from the boron provides for a greater likelihood than the cyano functionality can contact the cathode.

In some variations, m is 1. In some variations, m is 2. In some variations, m is 3. In some variations, m is 4. In some variations, m is 5. In some variations, m is 6. In some variations, m is 7. In some variations, m is 8. In some variations, m is 9.

In some variations, m is from 1 to 9. In further variations, m is from 1 to 3. In still further variations, m is from 1 to 2.

In some variations, m is 1 or greater. In some variations, m is 2 or greater. In some variations, m is 3 or greater. In some variations, m is 4 or greater. In some variations, m is 5 or greater. In some variations, m is 6 or greater. In some variations, m is 7 or greater. In some variations, m is 8 or greater. In some variations, m 9 or lower. In some variations, m 8 or lower. In some variations, m 7 or lower. In some variations, m 6 or lower. In some variations, m 5 or lower. In some variations, m 4 or lower. In some variations, m 3 or lower. In some variations, m 2 or lower.

As used herein, variable m indicates the number of carbons. In other words, the alkyl group structurally described by

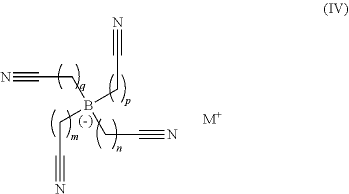

can be a saturated or unsaturated, branched, straight-chain alkyl group. The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds.

Where a specific level of saturation is intended, the expressions “alkanyl,” “alkenyl,” and “alkynyl” can be used.

“Alkanyl” refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Alkenyl” refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl, prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl , but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, etc.; and the like.

“Alkynyl” refers to an unsaturated branched, straight-chain or cyclic alkyl radical having at least one carbon-carbon triple bond derived by the removal of one hydrogen atom from a single carbon atom of a parent alkyne. Typical alkynyl groups include, but are not limited to, ethynyl; propynyls such as prop-1-yn-1-yl, prop-2-yn-1-yl, etc.; butynyls such as but-1-yn-1-yl, but-1-yn-3-yl, but-3-yn-1-yl, etc.; and the like.

The alkyl group define by

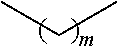

is substituted by one or more cyano moieties. In some variations, a cyano group substitutes a hydrogen on the terminal carbon of the alkyl group. In some variations, the terminal carbon of the alkyl group can have one, two, or three cyano substitutions. For example, when is n is 1 and the alkyl group is methyl, the carbon can be terminal carbon can be monosubstituted with a cyano group (forming an acetonitrile moiety), disubstituted with a cyano group (forming an malononitrile moiety), or trisubstituted with a cyano group (forming a methanetricarbonitrile moiety). Likewise, each carbon in the alkyl chain can have one or more hydrogens substituted.

Multiple carbons in the alkyl group defined by

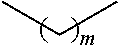

can be cyano substituted.

The cation M+ of Formula (I), (II), or (III) can be any cation known in the art. In some variations, the cation is lithium (Li⁺) and/or potassium (K⁺). In some variations the cation is Li⁺. In some variations the cation is K⁺.

In one variation, the electrolyte solution comprises an additive having the structure of Formula (II).

The variables m and n may vary independently of each other and in any combination, as detailed below.

Increasing the value of m extends the carbon chain from the boron provides for a greater likelihood than the cyano functionality can contact the cathode.

In some variations, m is 1. In some variations, m is 2. In some variations, m is 3. In some variations, m is 4. In some variations, m is 5. In some variations, m is 6. In some variations, m is 7. In some variations, m is 8. In some variations, m is 9.

In some variations, m is from 1 to 9. In further variations, m is from 1 to 3. In still further variations, m is from 1 to 2.

In some variations, m is 1 or greater. In some variations, m is 2 or greater. In some variations, m is 3 or greater. In some variations, m is 4 or greater. In some variations, m is 5 or greater. In some variations, m is 6 or greater. In some variations, m is 7 or greater. In some variations, m is 8 or greater. In some variations, m 9 or lower. In some variations, m 8 or lower. In some variations, m 7 or lower. In some variations, m 6 or lower. In some variations, m 5 or lower. In some variations, m 4 or lower. In some variations, m 3 or lower. In some variations, m 2 or lower.

Increasing the value of m and/or n extends the carbon chain from the boron provides for a greater likelihood than the cyano functionality can contact the cathode.

In some variations, n is 1. In some variations, n is 2. In some variations, n is 3. In some variations, n is 4. In some variations, n is 5. In some variations, n is 6. In some variations, n is 7. In some variations, n is 8. In some variations, n is 9.

In some variations, n is from 1 to 9. In further variations, n is from 1 to 3. In still further variations, n is from 1 to 2.

In some variations, n is 1 or greater. In some variations, n is 2 or greater. In some variations, n is 3 or greater. In some variations, n is 4 or greater. In some variations, n is 5 or greater. In some variations, n is 6 or greater. In some variations, n is 7 or greater. In some variations, n is 8 or greater. In some variations, n 9 or lower. In some variations, n 8 or lower. In some variations, n 7 or lower. In some variations, n 6 or lower. In some variations, n 5 or lower. In some variations, n 4 or lower. In some variations, n 3 or lower. In some variations, n 2 or lower.

In one variation, the electrolyte solution comprises an additive having the structure of Formula (III).

The variables m, n, and p may vary independently of each other and in any combination, as detailed below. In some variations, increasing the value of m, n, and/or p extends the carbon chains from the boron, and can provide a greater likelihood than the cyano functionality can contact the cathode.

In some variations, m is 1. In some variations, m is 2. In some variations, m is 3. In some variations, m is 4. In some variations, m is 5. In some variations, m is 6. In some variations, m is 7. In some variations, m is 8. In some variations, m is 9.

In some variations, m is from 1 to 9. In further variations, m is from 1 to 3. In still further variations, m is from 1 to 2.

In some variations, m is 1 or greater. In some variations, m is 2 or greater. In some variations, m is 3 or greater. In some variations, m is 4 or greater. In some variations, m is 5 or greater. In some variations, m is 6 or greater. In some variations, m is 7 or greater. In some variations, m is 8 or greater. In some variations, m 9 or lower. In some variations, m 8 or lower. In some variations, m 7 or lower. In some variations, m 6 or lower. In some variations, m 5 or lower. In some variations, m 4 or lower. In some variations, m 3 or lower. In some variations, m 2 or lower.

Increasing the value of n extends the carbon chain from the boron provides for a greater likelihood than the cyano functionality can contact the cathode.

In some variations, n is 1. In some variations, n is 2. In some variations, n is 3. In some variations, n is 4. In some variations, n is 5. In some variations, n is 6. In some variations, n is 7. In some variations, n is 8. In some variations, n is 9.

In some variations, n is from 1 to 9. In further variations, n is from 1 to 3. In still further variations, n is from 1 to 2.

In some variations, n is 1 or greater. In some variations, n is 2 or greater. In some variations, n is 3 or greater. In some variations, n is 4 or greater. In some variations, n is 5 or greater. In some variations, n is 6 or greater. In some variations, n is 7 or greater. In some variations, n is 8 or greater. In some variations, n 9 or lower. In some variations, n 8 or lower. In some variations, n 7 or lower. In some variations, n 6 or lower. In some variations, n 5 or lower. In some variations, n 4 or lower. In some variations, n 3 or lower. In some variations, n 2 or lower.

Increasing the value of p extends the carbon chain from the boron provides for a greater likelihood than the cyano functionality can contact the cathode.

In some variations, p is 1. In some variations, p is 2. In some variations, p is 3. In some variations, p is 4. In some variations, p is 5. In some variations, p is 6. In some variations, p is 7. In some variations, p is 8. In some variations, p is 9.

In some variations, p is from 1 to 9. In further variations, p is from 1 to 3. In still further variations, p is from 1 to 2.

In some variations, p is 1 or greater. In some variations, p is 2 or greater. In some variations, p is 3 or greater. In some variations, p is 4 or greater. In some variations, p is 5 or greater. In some variations, p is 6 or greater. In some variations, p is 7 or greater. In some variations, p is 8 or greater. In some variations, p 9 or lower. In some variations, p 8 or lower. In some variations, p 7 or lower. In some variations, p 6 or lower. In some variations, p 5 or lower. In some variations, p 4 or lower. In some variations, p 3 or lower. In some variations, p 2 or lower.

In one variation, the electrolyte solution comprises an additive having the structure of Formula (IV).

The variables m, n, p, and q may vary independently of each other and in any combination, as detailed below. In some variations, increasing the value of m, n, p, and or q extends the carbon chains from the boron, and can provide a greater likelihood than the cyano functionality can contact the cathode.

In some variations, m is 1. In some variations, m is 2. In some variations, m is 3. In some variations, m is 4. In some variations, m is 5. In some variations, m is 6. In some variations, m is 7. In some variations, m is 8. In some variations, m is 9.

In some variations, m is from 1 to 9. In further variations, m is from 1 to 3. In still further variations, m is from 1 to 2.

In some variations, m is 1 or greater. In some variations, m is 2 or greater. In some variations, m is 3 or greater. In some variations, m is 4 or greater. In some variations, m is 5 or greater. In some variations, m is 6 or greater. In some variations, m is 7 or greater. In some variations, m is 8 or greater. In some variations, m 9 or lower. In some variations, m 8 or lower. In some variations, m 7 or lower. In some variations, m 6 or lower. In some variations, m 5 or lower. In some variations, m 4 or lower. In some variations, m 3 or lower. In some variations, m 2 or lower.

Increasing the value of n extends the carbon chain from the boron provides for a greater likelihood than the cyano functionality can contact the cathode.

In some variations, n is 1. In some variations, n is 2. In some variations, n is 3. In some variations, n is 4. In some variations, n is 5. In some variations, n is 6. In some variations, n is 7. In some variations, n is 8. In some variations, n is 9.

In some variations, n is from 1 to 9. In further variations, n is from 1 to 3. In still further variations, n is from 1 to 2.

In some variations, n is 1 or greater. In some variations, n is 2 or greater. In some variations, n is 3 or greater. In some variations, n is 4 or greater. In some variations, n is 5 or greater. In some variations, n is 6 or greater. In some variations, n is 7 or greater. In some variations, n is 8 or greater. In some variations, n 9 or lower. In some variations, n 8 or lower. In some variations, n 7 or lower. In some variations, n 6 or lower. In some variations, n 5 or lower. In some variations, n 4 or lower. In some variations, n 3 or lower. In some variations, n 2 or lower.

Increasing the value of p extends the carbon chain from the boron provides for a greater likelihood than the cyano functionality can contact the cathode.

In some variations, p is 1. In some variations, p is 2. In some variations, p is 3. In some variations, p is 4. In some variations, p is 5. In some variations, p is 6. In some variations, p is 7. In some variations, p is 8. In some variations, p is 9.

In some variations, p is from 1 to 9. In further variations, p is from 1 to 3. In still further variations, p is from 1 to 2.

In some variations, p is 1 or greater. In some variations, p is 2 or greater. In some variations, p is 3 or greater. In some variations, p is 4 or greater. In some variations, p is 5 or greater. In some variations, p is 6 or greater. In some variations, p is 7 or greater. In some variations, p is 8 or greater. In some variations, p 9 or lower. In some variations, p 8 or lower. In some variations, p 7 or lower. In some variations, p 6 or lower. In some variations, p 5 or lower. In some variations, p 4 or lower. In some variations, p 3 or lower. In some variations, p 2 or lower.

Increasing the value of q extends the carbon chain from the boron provides for a greater likelihood than the cyano functionality can contact the cathode.

In some variations, q is 1. In some variations, q is 2. In some variations, q is 3. In some variations, q is 4. In some variations, q is 5. In some variations, q is 6. In some variations, q is 7. In some variations, q is 8. In some variations, q is 9.

In some variations, q is from 1 to 9. In further variations, q is from 1 to 3. In still further variations, q is from 1 to 2.

In some variations, q is 1 or greater. In some variations, q is 2 or greater. In some variations, q is 3 or greater. In some variations, q is 4 or greater. In some variations, q is 5 or greater. In some variations, q is 6 or greater. In some variations, q is 7 or greater. In some variations, q is 8 or greater. In some variations, q 9 or lower. In some variations, q 8 or lower. In some variations, q 7 or lower. In some variations, q 6 or lower. In some variations, q 5 or lower. In some variations, q 4 or lower. In some variations, q 3 or lower. In some variations, q 2 or lower.

When the additive is the compound of Formula (IV), m is an integer equal to or greater than 1 and equal to or less than 9, n is an integer equal to or greater than 1 and equal to or less than 9, p is an integer equal to or greater than 1 and equal to or less than 9, q is an integer equal to or greater than 1 and equal to or less than 9, and M⁺ is selected from an alkali metal ion, a quaternary ammonium ion, an imidazolium ion, and a quaternary phosphonium ion.

In some variations, the additive selected from a compound of Formula (I), Formula (II), Formula (III), and Formula (IV) is in an amount of at least 0.01 wt % of the electrolyte fluid. In some variations, the additive selected from a compound of Formula (I), Formula (II), Formula (III), and Formula (IV) is in an amount of at least 0.03 wt % of the electrolyte fluid. In some variations, the additive selected from a compound of Formula (I), Formula (II), Formula (III), and Formula (IV) is in an amount of at least 0.05 wt % of the electrolyte fluid. In some variations, the additive selected from a compound of Formula (I), Formula (II), Formula (III), and Formula (IV) is in an amount of at least 0.07 wt % of the electrolyte fluid. In some variations, the additive selected from a compound of Formula (I), Formula (II), Formula (III), and Formula (IV) is in an amount of at least 0.10 wt % of the electrolyte fluid. In some variations, the additive selected from a compound of Formula (I), Formula (II), Formula (III), and Formula (IV) is in an amount of at least 0.20 wt % of the electrolyte fluid. In some variations, the additive selected from a compound of Formula (I), Formula (II), Formula (III), and Formula (IV) is in an amount of at least 0.30 wt % of the electrolyte fluid. In some variations, the additive selected from a compound of Formula (I), Formula (II), Formula (III), and Formula (IV) is in an amount of at least 0.50 wt % of the electrolyte fluid. In some variations, the additive selected from a compound of Formula (I), Formula (II), Formula (III), and Formula (IV) is in an amount of at least 0.75 wt % of the electrolyte fluid. In some variations, the additive selected from a compound of Formula (I), Formula (II), Formula (III), and Formula (IV) is in an amount of at least 1.0 wt % of the electrolyte fluid. In some variations, the additive selected from a compound of Formula (I), Formula (II), Formula (III), and Formula (IV) is in an amount of at least 1.25 wt % of the electrolyte fluid. In some variations, the additive selected from a compound of Formula (I), Formula (II), Formula (III), and Formula (IV) is in an amount of at least 1.50% of the electrolyte fluid. In some variations, the additive selected from a compound of Formula (I), Formula (II), Formula (III), and Formula (IV) is in an amount of at least 1.75 wt % of the electrolyte fluid. In some variations, the additive selected from a compound of Formula (I), Formula (II), Formula (III), and Formula (IV) is in an amount of at least 2.00 wt % of the electrolyte fluid. In some variations, the additive selected from a compound of Formula (I), Formula (II), Formula (III), and Formula (IV) is in an amount of at least 2.25 wt % of the electrolyte fluid. In some variations, the additive selected from a compound of Formula (I), Formula (II), Formula (III), and Formula (IV) is in an amount of at least 2.50 wt % of the electrolyte fluid. In some variations, the additive selected from a compound of Formula (I), Formula (II), Formula (III), and Formula (IV) is in an amount of at least 2.75 wt % of the electrolyte fluid. In some variations, the additive selected from a compound of Formula (I), Formula (II), Formula (III), and Formula (IV) is in an amount of at least 3.0 wt % of the electrolyte fluid. In some variations, the additive selected from a compound of Formula (I), Formula (II), Formula (III), and Formula (IV) is in an amount of at least 3.25 wt % of the electrolyte fluid. In some variations, the additive selected from a compound of Formula (I), Formula (II), Formula (III), and Formula (IV) is in an amount of at least 3.50 wt % of the electrolyte fluid. In some variations, the additive selected from a compound of Formula (I), Formula (II), Formula (III), and Formula (IV) is in an amount of at least 3.75 wt % of the electrolyte fluid. In some variations, the additive selected from a compound of Formula (I), Formula (II), Formula (III), and Formula (IV) is in an amount of at least 4.00 wt % of the electrolyte fluid. In some variations, the additive selected from a compound of Formula (I), Formula (II), Formula (III), and Formula (IV) is in an amount of at least 4.25 wt % of the electrolyte fluid. In some variations, the additive selected from a compound of Formula (I), Formula (II), Formula (III), and Formula (IV) is in an amount of at least 4.50 wt % of the electrolyte fluid. In some variations, the additive selected from a compound of Formula (I), Formula (II), Formula (III), and Formula (IV) is in an amount of at least 4.75 wt % of the electrolyte fluid.

In some variations, the additive selected from a compound of Formula (I), Formula (II), Formula (III), and Formula (IV) is in an amount of equal to or less than 5.0 wt % of the electrolyte fluid. In some variations, the additive selected from a compound of Formula (I), Formula (II), Formula (III), and Formula (IV) is in an amount of equal to or less than 4.75 wt % of the electrolyte fluid. In some variations, the additive selected from a compound of Formula (I), Formula (II), Formula (III), and Formula (IV) is in an amount of equal to or less than 4.50 wt % of the electrolyte fluid. In some variations, the additive selected from a compound of Formula (I), Formula (II), Formula (III), and Formula (IV) is in an amount of equal to or less than 4.25 wt % of the electrolyte fluid. In some variations, the additive selected from a compound of Formula (I), Formula (II), Formula (III), and Formula (IV) is in an amount of equal to or less than 4.00 wt % of the electrolyte fluid. In some variations, the additive selected from a compound of Formula (I), Formula (II), Formula (III), and Formula (IV) is in an amount of equal to or less than 3.75 wt % of the electrolyte fluid. In some variations, the additive selected from a compound of Formula (I), Formula (II), Formula (III), and Formula (IV) is in an amount of equal to or less than 3.50 wt % of the electrolyte fluid. In some variations, the additive selected from a compound of Formula (I), Formula (II), Formula (III), and Formula (IV) is in an amount of equal to or less than 3.25 wt % of the electrolyte fluid. In some variations, the additive selected from a compound of Formula (I), Formula (II), Formula (III), and Formula (IV) is in an amount of equal to or less than 3.00 wt % of the electrolyte fluid. In some variations, the additive selected from a compound of Formula (I), Formula (II), Formula (III), and Formula (IV) is in an amount of equal to or less than 2.75 wt % of the electrolyte fluid. In some variations, the additive selected from a compound of Formula (I), Formula (II), Formula (III), and Formula (IV) is in an amount of equal to or less than 2.50 wt % of the electrolyte fluid. In some variations, the additive selected from a compound of Formula (I), Formula (II), Formula (III), and Formula (IV) is in an amount of equal to or less than 2.25 wt % of the electrolyte fluid. In some variations, the additive selected from a compound of Formula (I), Formula (II), Formula (III), and Formula (IV) is in an amount of equal to or less than 2.00 wt % of the electrolyte fluid. In some variations, the additive selected from a compound of Formula (I), Formula (II), Formula (III), and Formula (IV) is in an amount of equal to or less than 1.75 wt % of the electrolyte fluid. In some variations, the additive selected from a compound of Formula (I), Formula (II), Formula (III), and Formula (IV) is in an amount of equal to or less than 1.50 wt % of the electrolyte fluid. In some variations, the additive selected from a compound of Formula (I), Formula (II), Formula (III), and Formula (IV) is in an amount of equal to or less than 1.25 wt % of the electrolyte fluid. In some variations, the additive selected from a compound of Formula (I), Formula (II), Formula (III), and Formula (IV) is in an amount of equal to or less than 1.00 wt % of the electrolyte fluid. In some variations, the additive selected from a compound of Formula (I), Formula (II), Formula (III), and Formula (IV) is in an amount of equal to or less than 0.75 wt % of the electrolyte fluid. In some variations, the additive selected from a compound of Formula (I), Formula (II), Formula (III), and Formula (IV) is in an amount of equal to or less than 0.50 wt % of the electrolyte fluid. In some variations, the additive selected from a compound of Formula (I), Formula (II), Formula (III), and Formula (IV) is in an amount of equal to or less than 0.30 wt % of the electrolyte fluid. In some variations, the additive selected from a compound of Formula (I), Formula (II), Formula (III), and Formula (IV) is in an amount of equal to or less than 0.20 wt % of the electrolyte fluid. In some variations, the additive selected from a compound of Formula (I), Formula (II), Formula (III), and Formula (IV) is in an amount of equal to or less than 0.10 wt % of the electrolyte fluid. In some variations, the additive selected from a compound of Formula (I), Formula (II), Formula (III), and Formula (IV) is in an amount of equal to or less than 0.08 wt % of the electrolyte fluid. In some variations, the additive selected from a compound of Formula (I), Formula (II), Formula (III), and Formula (IV) is in an amount of equal to or less than 0.06 wt % of the electrolyte fluid. In some variations, the additive selected from a compound of Formula (I), Formula (II), Formula (III), and Formula (IV) is in an amount of equal to or less than 0.04 wt % of the electrolyte fluid. In some variations, the additive selected from a compound of Formula (I), Formula (II), Formula (III), and Formula (IV) is in an amount of equal to or less than 0.03 wt % of the electrolyte fluid. In some variations, the additive selected from a compound of Formula (I), Formula (II), Formula (III), and Formula (IV) is in an amount of equal to or less than 0.02 wt % of the electrolyte fluid.

In some variations, the electrolyte fluid can include one or more additives. In various aspects, the additives can include lithium difluoro(oxalato)borate (LiDFOB), pro-1-ene-1, 3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and/or 1,3,6-hexanetricarbonitrile (HTCN), in any combination, and in ranges of quantities.

In some variations, LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LiDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid.

In some variations, LiDFOB is less than or equal to 2.0 wt % of the total electrolyte fluid. In some variations, LiDFOB is less than or equal to 1.9 wt % of the total electrolyte fluid. In some variations, LiDFOB is less than or equal to 1.3 wt % of the total electrolyte fluid. In some variations, LiDFOB is less than or equal to 1.3 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

In some variations, the amount of PES is at least 0.5 wt % of the total electrolyte fluid. In some variations, the amount of PES is at least 0.6 wt % of the total electrolyte fluid. In some variations, the amount of PES is at least 0.9 wt % of the total electrolyte fluid. In some variations, the amount of PES is at least 1.3 wt % of the total electrolyte fluid. In some variations, the amount of PES is at least 1.6 wt % of the total electrolyte fluid. In some variations, the amount of PES is at least 1.9 wt % of the total electrolyte fluid. In some variations, the amount of PES is at least 2.2 wt % of the total electrolyte fluid. In some variations, the amount of PES is at least 2.5 wt % of the total electrolyte fluid. In some variations, the amount of PES is at least 2.8 wt % of the total electrolyte fluid. In some variations, the amount of PES is at least 3.1 wt % of the total electrolyte fluid.

In some variations, the amount of PES is less than or equal to 3.5 wt % of the total electrolyte fluid. In some variations, the amount of PES is less than or equal to 3.1 wt % of the total electrolyte fluid. In some variations, the amount of PES is less than or equal to 2.8 wt % of the total electrolyte fluid. In some variations, the amount of PES is less than or equal to 2.5 wt % of the total electrolyte fluid. In some variations, the amount of PES is less than or equal to 2.2 wt % of the total electrolyte fluid. In some variations, the amount of PES is less than or equal to 1.9 wt % of the total electrolyte fluid. In some variations, the amount of PES is less than or equal to 1.6 wt % of the total electrolyte fluid. In some variations, the amount of PES is less than or equal to 1.3 wt % of the total electrolyte fluid. In some variations, the amount of PES is less than or equal to 1.1 wt % of the total electrolyte fluid. In some variations, the amount of PES is less than or equal to 0.9 wt % of the total electrolyte fluid. In some variations, the amount of PES is less than or equal to 0.6 wt % of the total electrolyte fluid.

In some variations, the amount of MMDS is at least 0.1 wt % of the total electrolyte fluid. In some variations, the amount of MMDS is at least 0.2 wt % of the total electrolyte fluid. In some variations, the amount of MMDS is at least 0.3 wt % of the total electrolyte fluid. In some variations, the amount of MMDS is at least 0.4 wt % of the total electrolyte fluid. In some variations, the amount of MMDS is at least 0.5 wt % of the total electrolyte fluid. In some variations, the amount of MMDS is at least 0.6 wt % of the total electrolyte fluid. In some variations, the amount of MMDS is at least 0.7 wt % of the total electrolyte fluid. In some variations, the amount of MMDS is at least 0.8 wt % of the total electrolyte fluid. In some variations, the amount of MMDS is at least 0.9 wt % of the total electrolyte fluid. In some variations, the amount of MMDS is at least 1.0 wt % of the total electrolyte fluid. In some variations, the amount of MMDS is at least 1.1 wt % of the total electrolyte fluid. In some variations, the amount of MMDS is at least 1.2 wt % of the total electrolyte fluid. In some variations, the amount of MMDS is at least 1.3 wt % of the total electrolyte fluid. In some variations, the amount of MMDS is at least 1.4 wt % of the total electrolyte fluid.

In some variations, the amount of MMDS is less than or equal to 1.5 wt % of the total electrolyte fluid. In some variations, the amount of MMDS is less than or equal to 1.4 wt % of the total electrolyte fluid. In some variations, the amount of MMDS is less than or equal to 1.3 wt % of the total electrolyte fluid. In some variations, the amount of MMDS is less than or equal to 1.2 wt % of the total electrolyte fluid. In some variations, the amount of MMDS is less than or equal to 1.1 wt % of the total electrolyte fluid. In some variations, the amount of MMDS is less than or equal to 1.0 wt % of the total electrolyte fluid. In some variations, the amount of MMDS is less than or equal to 0.9 wt % of the total electrolyte fluid. In some variations, the amount of MMDS is less than or equal to 0.8 wt % of the total electrolyte fluid. In some variations, the amount of MMDS is less than or equal to 0.7 wt % of the total electrolyte fluid. In some variations, the amount of MMDS is less than or equal to 0.6 wt % of the total electrolyte fluid. In some variations, the amount of MMDS is less than or equal to 0.5 wt % of the total electrolyte fluid. In some variations, the amount of MMDS is less than or equal to 0.4 wt % of the total electrolyte fluid. In some variations, the amount of MMDS is less than or equal to 0.3 wt % of the total electrolyte fluid. In some variations, the amount of MMDS is less than or equal to 0.2 wt % of the total electrolyte fluid.

In some variations, the amount of VEC is at least 0.1 wt % of the total electrolyte fluid. In some variations, the amount of VEC is at least 0.2 wt % of the total electrolyte fluid. In some variations, the amount of VEC is at least 0.3 wt % of the total electrolyte fluid. In some variations, the amount of VEC is at least 0.4 wt % of the total electrolyte fluid. In some variations, the amount of VEC is at least 0.5 wt % of the total electrolyte fluid. In some variations, the amount of VEC is at least 0.6 wt % of the total electrolyte fluid. In some variations, the amount of VEC is at least 0.7 wt % of the total electrolyte fluid. In some variations, the amount of VEC is at least 0.8 wt % of the total electrolyte fluid. In some variations, the amount of VEC is at least 0.9 wt % of the total electrolyte fluid.

In some variations, the amount of VEC is less than or equal to 0.9 wt % of the total electrolyte fluid. In some variations, the amount of VEC is less than or equal to 0.8 wt % of the total electrolyte fluid. In some variations, the amount of VEC is less than or equal to 0.7 wt % of the total electrolyte fluid. In some variations, the amount of VEC is less than or equal to 0.6 wt % of the total electrolyte fluid. In some variations, the amount of VEC is less than or equal to 0.5 wt % of the total electrolyte fluid. In some variations, the amount of VEC is less than or equal to 0.4 wt % of the total electrolyte fluid. In some variations, the amount of VEC is less than or equal to 0.3 wt % of the total electrolyte fluid. In some variations, the amount of VEC is less than or equal to 0.2 wt % of the total electrolyte fluid.

In some variations, the amount of FEC is at least 2 wt % of the total electrolyte fluid. In some variations, the amount of FEC is at least 4 wt % of the total electrolyte fluid. In some variations, the amount of FEC is at least 6 wt % of the total electrolyte fluid. In some variations, the amount of FEC is at least 8 wt % of the total electrolyte fluid. In some variations, the amount of FEC is less than or equal to 10 wt % of the total electrolyte fluid. In some variations, the amount of FEC is less than or equal to 8 wt % of the total electrolyte fluid. In some variations, the amount of FEC is less than or equal to 6 wt % of the total electrolyte fluid. In some variations, the amount of FEC is less than or equal to 4 wt % of the total electrolyte fluid.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid.

In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

In some variations, the amount of SN is at least 0.5 wt % of the total electrolyte fluid. In some variations, the amount of SN is at least 1.0 wt % of the total electrolyte fluid. In some variations, the amount of SN is at least 1.5 wt % of the total electrolyte fluid. In some variations, the amount of SN is at least 2.0 wt % of the total electrolyte fluid. In some variations, the amount of SN is at least 2.5 wt % of the total electrolyte fluid. In some variations, the amount of SN is at least 3.0 wt % of the total electrolyte fluid. In some variations, the amount of SN is at least 3.5 wt % of the total electrolyte fluid. In some variations, the amount of SN is at least 4.0 wt % of the total electrolyte fluid. In some variations, the amount of SN is at least 4.5 wt % of the total electrolyte fluid. In some variations, the amount of SN is at least 5.0 wt % of the total electrolyte fluid.

In some variations, the amount of SN is less than or equal to 6.0 wt % of the total electrolyte fluid. In some variations, the amount of SN is less than or equal to 5.5 wt % of the total electrolyte fluid. In some variations, the amount of SN is less than or equal to 5.0 wt % of the total electrolyte fluid. In some variations, the amount of SN is less than or equal to 4.5 wt % of the total electrolyte fluid. In some variations, the amount of SN is less than or equal to 4.0 wt % of the total electrolyte fluid. In some variations, the amount of SN is less than or equal to 3.5 wt % of the total electrolyte fluid. In some variations, the amount of SN is less than or equal to 3.0 wt % of the total electrolyte fluid. In some variations, the amount of SN is less than or equal to 2.5 wt % of the total electrolyte fluid. In some variations, the amount of SN is less than or equal to 2.0 wt % of the total electrolyte fluid. In some variations, the amount of SN is less than or equal to 1.5 wt % of the total electrolyte fluid. In some variations, the amount of SN is less than or equal to 1.0 wt % of the total electrolyte fluid.

In some variations, the amount of HTCN is at least 0.01 wt % of the total electrolyte fluid. In some variations, the amount of HTCN is at least 0.1 wt % of the total electrolyte fluid. In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid. In some variations, the amount of HTCN is at least 5.0 wt % of the total electrolyte fluid. In some variations, the amount of HTCN is at least 5.5 wt % of the total electrolyte fluid.

In some variations, the amount of HTCN is less than or equal to 6.0 wt % of the total electrolyte fluid. In some variations, the amount of HTCN is less than or equal to 5.5 wt % of the total electrolyte fluid. In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid.

The electrolyte solvent may also have a salt dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂CF₃)₂, LiBC₄O₈, Li[PF₃(C₂CF₅)₃], and LiC(SO₂CF₃)₃. Other salts are possible, including combinations of salts.

### EXAMPLES

The Examples are provided for illustration purposes only. These examples are not intended to constrain any embodiment disclosed herein to any application or theory of operation.

### Example 1

Various battery cell properties were tested with the electrolyte fluid including PCTFB, and compared to a battery cell with a control electrolyte fluid lacking PCTFB. The composition of the control electrolyte fluid is show in Table 1.

TABLE 1

| Salt/M | Solvent wt % | | | | Additives wt % | | |
|---|---|---|---|---|---|---|---|
| LiPF6 | EC | PC | PP | EP | PS | FEC | SN |
| 1.2 | 20 | 10 | 45 | 25 | 4 | 7 | 3 |

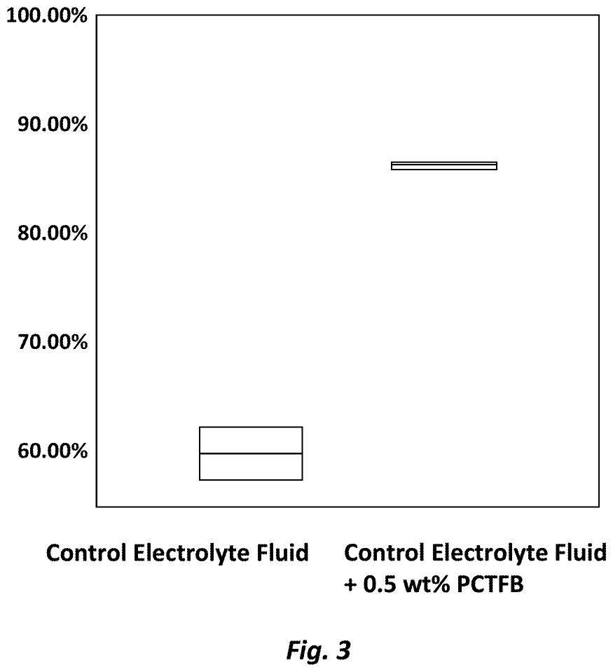

FIG. 3 presents the energy retention at cycle 200 for a battery operating at 45° C. of the control electrolyte as compared to the control including 0.5 wt % PCTFB. When the control electrolyte was used in the absence of PCTFB, the energy retention at cycle 200 was approximately 60%, Upon the addition of 0.5 wt % PCTFB, the energy retention at cycle 200 was over 85%. The addition of PCTFB resulted in a substantial increase in energy retention at high cycle times.

### Example 2

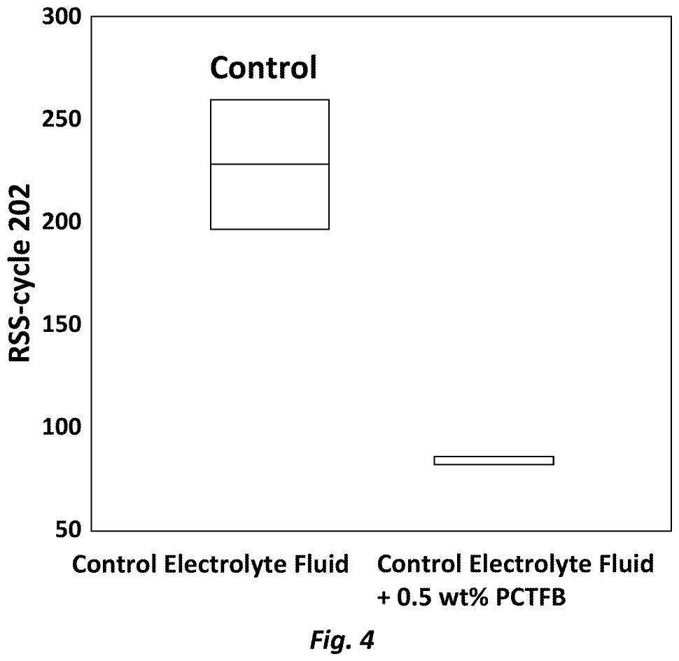

FIG. 4 presents the RSS at cycle 202 for a control electrolyte and the control electrolyte including PCTFB. The battery resistance was substantially higher in the absence of PCTFB. In the absence of 0.5 wt % PCTFB the resistance at cycle number 202 was from 200-250. When the electrolyte formulation included 0.5 wt % PCTFB, the RSS was less than 75.

### Example 3

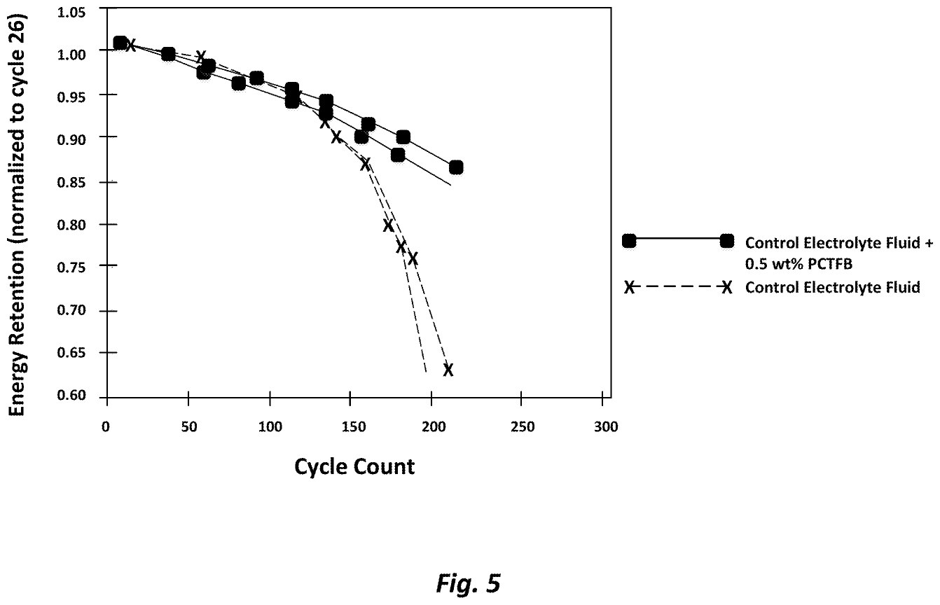

FIG. 5 presents the energy retention normalized to cycle 25 as a function of cycle count at 45° C. for a battery having a control electrolyte and an electrolyte including 0.5 wt % PCTFB. The energy retention is roughly similar through 100 cycles. However, the energy retention begins to fall precipitously in the absence of PCTFB. The data demonstrate that the presence of PCTFB in electrolytes substantially improves energy retention in battery cells as cycle count increases.

### Example 4

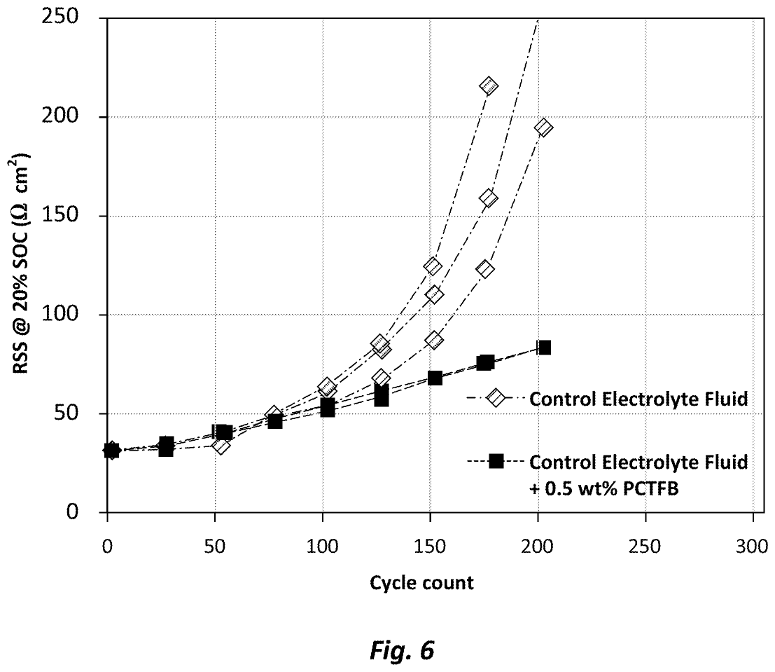

FIG. 6 depicts a plot of RSS as a function of battery cycle count at 45° C. for a battery having a control electrolyte and an electrolyte including 0.5 wt % PCTFB. Three trials were measured with and without PCTFB. The RSS of the battery cells with and without PCTFB was roughly similar through 75 cycles. However, the energy retention began to increase substantially in the absence of PCTFB. PCTFB in electrolyte fluids substantially lowered RSS in battery cells as cycle count increased.

The recovery capacity after storage was measured for battery cells having a control electrolyte fluid, the control electrolyte fluid with 0.3 wt % PCTFB, and the control electrolyte fluid 0.3 wt % PCTFB. As depicted in Table 2, batteries having a control electrolyte fluid had a lower recovery capacity than the recovery capacity of a battery in which the electrolyte fluid included 0.3 wt % PCTFB or 0.5 wt % PCTFB.

TABLE 2

| | Remaining | Recovery Cap % | |
|---|---|---|---|
| Alloy ID | Cap % | Cycle 1 | Cycle 3 |
| 2 | 85.4 +/− 1 | 90.8 +/− 1 | 96.9 +/− 0.5 |
| 2 + 0.5 wt % PCTFB | 90.4 +/− 6.5 | 95.7 +/− 2 | 96.2 +/− 1.6 |
| 2 + 0.3 wt % PCTFB | 84.6 +/− 6.4 | 94.0 +/− 3.4 | 96.8 +/− 0.8 |

### Example 5

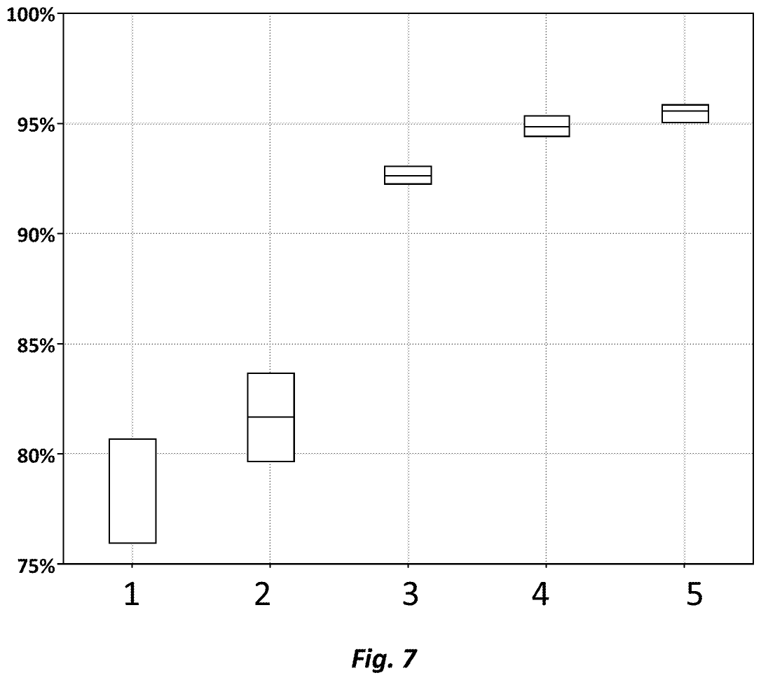

FIG. 7 depicts the capacity recovery of different electrolyte compositions after battery storage 85° C. The electrolyte solvent compositions are described in Table 3, and the additive compositions are described in Table 4:

TABLE 3

| Electrolyte | LiPF6 | | | | |
|---|---|---|---|---|---|
| Fluid No. | (moles) | EC (wt %) | PC (wt %) | PP (wt %) | EP (wt %) |
| 1 | 1.2 | 20 | 10 | 45 | 25 |
| 2 | 1.2 | 20 | 10 | 45 | 25 |
| 3 | 1.2 | 20 | 10 | 45 | 25 |
| 4 | 1.2 | 20 | 10 | 45 | 25 |
| 5 | 1.2 | 20 | 10 | 45 | 25 |

TABLE 4

| Electrolyte Fluid No. | LiDFOB | VEC | MMDS | SN | FEC | PS | LiCTFB | PES | HTCN |
|---|---|---|---|---|---|---|---|---|---|
| 1 | 0.7 | | 0.5 | 2 | 7 | 2.5 | | 1.5 | 3 |
| 2 | 0.5 | 0.5 | | 2 | | 4 | | | 3 |
| 3 | 0.5 | | | 2 | | 4 | | | 3 |
| 4 | 0.5 | | | 2 | | 4 | | | 1 |
| 5 | 0.5 | | | 2 | | 4 | 0.2 | | 1 |

With reference to FIG. 7, Electrolyte Fluids 1, 2, and 3 have 3.0 wt % HTCN, while Electrolyte Fluids 4 and 5 have 1.0 wt % HTCN. By reducing the percent HTCN to 1.0 wt %, an improved high temperature recovery capacity was observed. The recovery capacity upon introducing 0.2 wt % LiCTFB improved the high temperature recovery capacity in comparison to electrolyte composition without LiCTFB.

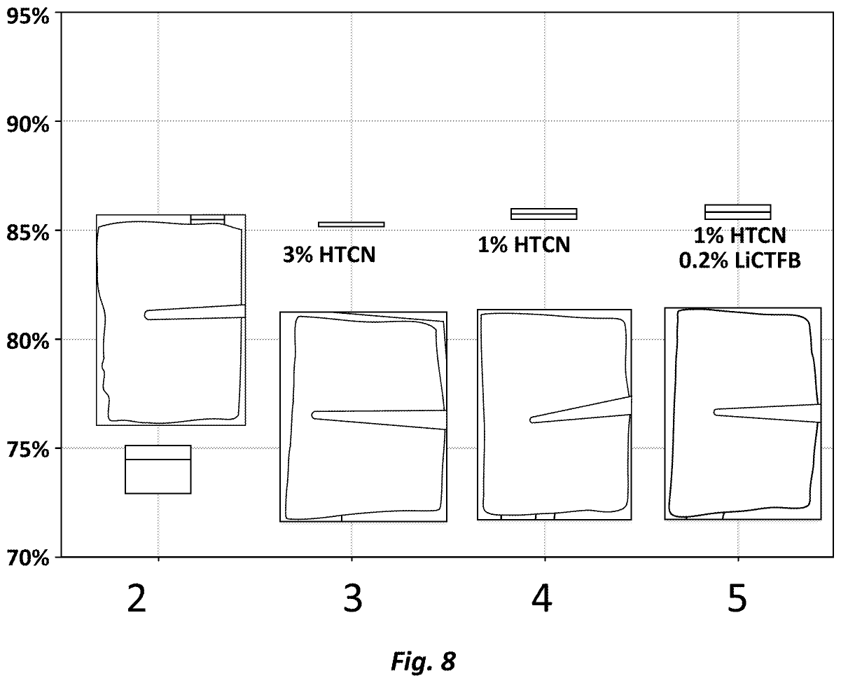

FIG. 8 depicts low temperature cycling for batteries having electrolyte fluids containing different combinations of additives. At low temperatures, lithium mobility can decrease. Addition of HTCN results in passivation of the cathode surface, thereby also increasing internal resistance. Electrolyte fluids containing 3.0 wt % HTCN shows lower higher internal resistance as compared to lower amounts of HTCN. Electrolyte fluids having 1 wt % HTCN shows a slight improvement as compared to 3.0 wt % HTCN. Adding 0.2 wt % LiCTFB provides higher capacity at lower temperature.

### Example 6

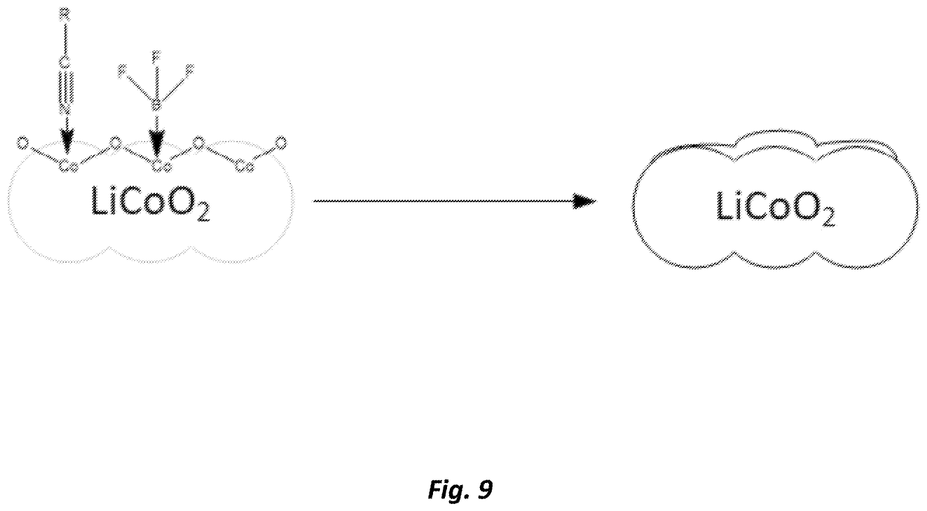

Without wishing to be limited to any particular mechanism or mode of action, the cyano functionality can act as a protective agent to the to the cathode. FIG. 9 depicts a cobalt oxide or modified cobalt oxide (e.g., LiCoMₓO) cathode active material interface 300 with the electrolyte 302. Compounds of Formula (I), (II), (III), or (IV) can incorporate two CEI-forming functional groups CN and BF₃ in a single structure. When a compound of Formula (I), (II), (III), or (IV) encounters and absorbs onto the cathode active material LiCoMₓO surface, the compound can oxidize to create a CEI 304 at the surface of cathode active material 306, thereby passivating the surface of cathode active material 306. The cyano functionality can bind cobalt, and the boron functionality can bind oxygen. The presence of the CN functionality and/or BF₃ functionality bound to cobalt oxide or modified cobalt oxide (e.g., LiCoMₓO) cathode active materials can inhibit the ability of other electrolyte components from contacting and possibly degrading the cathode active material. In different variations, compounds of Formula (I), (II), (III), or (IV) can have a lower impact on internal resistance than other passivation compounds.

### Example 7

LiCTFB can be synthesized from a potassium cation to a lithium cation. The initial potassium cation compound to lithiate the compound of Formula (I), (II), (III), or (IV) by combining the compound with LiBF₄. The reaction results in a formation of LiCTFB and KBF₄ precipitate.

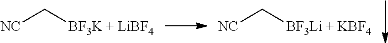

The electrolyte fluids described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electrolyte fluid comprising at least 0.01 wt % of an additive selected from a compound of Formula (IV): 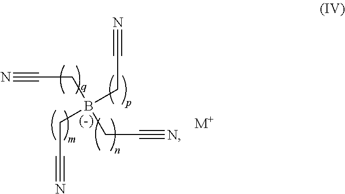
wherein
m is an integer equal to or greater than 1 and equal to or less than 9,
n is an integer equal to or greater than 1 and equal to or less than 9,
p is an integer equal to or greater than 1 and equal to or less than 9,
q is an integer equal to or greater than 1 and equal to or less than 9, and
M⁺ is selected from an alkali metal ion, a quaternary ammonium ion, an imidazolium ion, and a quaternary phosphonium ion.

2. The electrolyte fluid of claim 1, wherein m is from 1 to 3.

3. The electrolyte fluid of claim 1, wherein m is from 1 to 2.

4. The electrolyte fluid of claim 1, wherein n is from 1 to 3.

5. The electrolyte fluid of claim 1, wherein n is from 1 to 2.

6. The electrolyte fluid of claim 1, wherein p is from 1 to 3.

7. The electrolyte fluid of claim 1, wherein p is from 1 to 2.

8. The electrolyte fluid of claim 1, wherein q is from 1 to 3.

9. The electrolyte fluid of claim 1, wherein q is from 1 to 2.

10. The electrolyte fluid of claim 1, comprising an electrolyte salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

11. The electrolyte fluid of claim 10, wherein the salt comprises LiPF₆.

12. The electrolyte fluid of one of claim 11, wherein the salt is from 0.8 M to 1.6 M.

13. The electrolyte fluid of claim 1, comprising a solvent selected from ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), and butyl acetate (BA), and a combination thereof.

14. The electrolyte fluid of claim 13, wherein the solvent is selected from PC, EC, PP, EP, and a combination thereof.

15. The electrolyte fluid of claim 13, wherein the solvent comprises PC, EC, PP, and EP.

16. The electrolyte fluid of claim 13, wherein PC is from 2 to 20 wt % of the total electrolyte fluid, EC is from 5 to 40 wt % of the total electrolyte fluid, PP is from 20 to 70 wt % of the total electrolyte fluid, and/or EP is from 10 to 50 wt % of the total electrolyte fluid.

17. The electrolyte fluid of claim 1, comprising an additive selected from lithium difluoro(oxalato)borate (LiDFOB), pro-1-ene-1, 3-sultone (PES), methylene methanedisulfonate (MMDS), propylene carbonate (PC), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and a combination thereof.

18. The electrolyte fluid of claim 17, wherein the additive is selected from LiDFOB, PES, MMDS, PS, FEC, SN, and a combination thereof.

19. The electrolyte fluid of claim 18, wherein the additive comprises LiDFOB, PES, MMDS, PS, FEC, and SN.

20. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid according to claim 1 disposed between the cathode and anode.
